(19) United States
(12) Patent Application Publication
(10) Pub. No.: US 2020/0359431 A1
(43) Pub. Date: Nov. 12, 2020

(54) COMMUNICATION SYSTEM, MOBILE TERMINAL, AND IN-VEHICLE APPARATUS

(71) Applicant: DENSO CORPORATION, Kariya-city (JP)

(72) Inventors: Hiroshi KUWAHARA, Kariya-city (JP); Yousuke KIMURA, Kariya-city (JP); Masatoshi ABO, Kariya-city (JP)

(21) Appl. No.: 16/852,643

(22) Filed: Apr. 20, 2020

(30) Foreign Application Priority Data
May 9, 2019 (JP) 2019-089074

(51) Int. Cl. H04W 76/11; H04W 4/48; H04W 12/04; H04W 4/80

(52) U.S. Cl. CPC H04W 76/11; H04W 4/80; H04W 12/0401; H04W 4/48

(57) ABSTRACT

A communication system including a first communication apparatus and a second communication apparatus performing wireless communication with each other. The first communication apparatus randomly generates identification information, and displays specification information enabled to specify the identification information. The second communication apparatus acquires the specification information displayed by the first communication apparatus, specifies the identification information based on the specification information, and transmits wirelessly, by broadcast, broadcast information including the identification information.

### CROSS REFERENCE TO RELATED APPLICATION

The present application claims the benefit of priority from Japanese Patent Application No. 2019-089074 filed on May 9, 2019. The entire disclosure of the above application is incorporated herein by reference.

### TECHNICAL FIELD

The present disclosure relates to a communication system including a plurality of communication apparatuses.

### BACKGROUND

In a communication system, a communication apparatus receives an advertisement packet wirelessly transmitted by broadcast from another communication apparatus and establishes a communication connection based on the advertisement packet.

According to an example of the present disclosure, a communication system including a first communication apparatus and a second communication apparatus performing wireless communication with each other. The first communication apparatus randomly generates identification information, and displays specification information enabled to specify the identification information. The second communication apparatus acquires the specification information displayed by the first communication apparatus, specifies the identification information based on the specification information, and transmits wirelessly, by broadcast, broadcast information including the identification information.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram illustrating a configuration of a destination setting system;

FIG. 2 is a flowchart illustrating a destination setting process according to a first embodiment;

FIG. 3 is a flowchart illustrating a destination transmission process according to the first embodiment:

FIG. 4 is a diagram showing a procedure up to establishing a connection between a navigation apparatus and a smartphone according to the first embodiment;

FIG. 5 is a flowchart illustrating a destination setting process according to a second embodiment;

FIG. 6 is a flowchart illustrating a destination transmission process according to the second embodiment; and

FIG. 7 is a diagram showing a procedure up to establishing a connection between a navigation apparatus and a smartphone according to the second embodiment.

### DETAILED DESCRIPTION

### First Embodiment

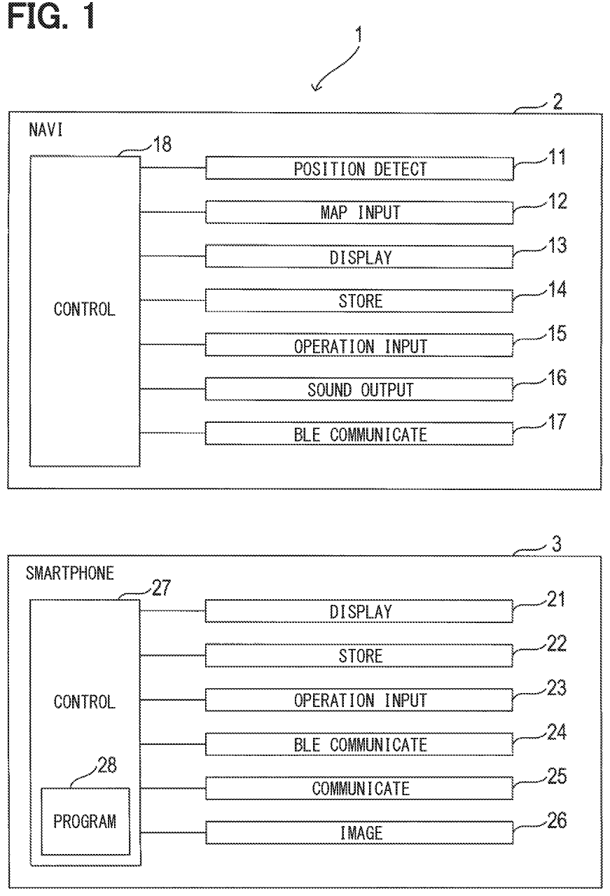

Hereinafter, a first embodiment of the present disclosure will be described with reference to the drawings. A destination setting system 1 according to the present embodiment includes a navigation apparatus 2 and a smartphone 3 as shown in FIG. 1.

The navigation apparatus 2, which is mounted on a vehicle, includes a position detector device 11, a map data input device 12, a display device 13, a data storage device 14, an operation input device 15, a sound output device 16, a BLE communicator device 17, and a controller device 18.

The position detector device 11, which may also be referred to as a position detector, includes a GPS receiver that receives satellite signals from GPS satellites, and detects the position of the navigation apparatus 2 based on signals received from the GPS satellites. GPS is an abbreviation for Global Positioning System.

The map data input device 12, which may also be referred to as a map data reader device, or a map data reader, is a device for inputting various data stored in a map storage medium (not shown). The map storage medium stores map data (node data, link data, cost data, road data, terrain data, mark data, intersection data, temporary stop point data, facility data, etc.). The storage medium for storing such data include a hard disk and a memory card.

The display device 13, which may also be referred to as a display, is a display device that displays various images on a display screen. The data storage device 14, which may also be referred to as a data storage or memory, is a storage device for storing various data. The operation input device 15, which may also be referred to as an operation input interface device or an operation input interface, includes (i) a touch panel installed on the display screen of the display device 13 and (ii) switches arranged around the display screen of the display device 13. The operation input device 15 outputs input operation information for specifying an input operation performed by a user via the touch panel or the switches.

The sound output device 16, which may also be referred to as a sound output interface device, a sound output interface, or a speaker, is installed in the vehicle interior, and notifies the occupant of the vehicle of various kinds of information by sound and/or speech. The BLE communicator device 17, which may also be referred to as a BLE communicator, or a BLE transceiver, performs short-range wireless communication using a method based on BLE, which is an extended specification of Bluetooth. Bluetooth is a registered trademark. BLE is an abbreviation for Bluetooth Low Energy.

The controller device 18, which may also be referred to as a controller, a control circuit, or a processor, is an electronic control apparatus mainly configured as a microcomputer (i.e., computer). As one example of the present embodiment, such a computer is configured to include a CPU, a ROM, a RAM, and I/O interfaces. Various functions of the microcomputer are realized by allowing the CPU to execute a program stored in a non-transitory tangible storage medium. In this example, the ROM corresponds to a non-transitory tangible storage medium in which the program is stored. A method corresponding to the program is executed by executing the program by the CPU. A part or all of the functions executed by the CPU may be configured as hardware by one or more ICs or the like. The number of microcomputers constituting the controller device 18 may be one or more.

The controller device 18 executes various processes based on inputs from the position detector device 11, the map data input device 12, the data storage device 14, the operation input device 15, and the BLE communicator device 17, and controls the display device 13, the data storage device 14, the sound output device 16, and the BLE communicator device 17.

Then, the controller device 18 executes a current position display process for displaying the current position of the vehicle on the display screen in the display device 13. When receiving the input operation information for setting a destination from the operation input device 15, the controller device 18 executes a route guidance process for performing a guidance of a route from the current location to the destination.

The smartphone 3 includes a display device 21, a data storage device 22, an operation input device 23, a BLE communicator device 24, a communicator device 25, an imager device 26, and a controller device 27. The display device 21, which may also be referred to as a display, is a display for displaying various images on a display screen. The data storage device 22, which may also be referred to as a data storage or memory, is a storage device for storing various data.

The operation input device 23, which may also be referred to as an operation input interface device, or an operation input interface, includes a touch panel provided on a display screen in the display device 21 and a switch provided around the display screen of the display device 21. Then, the operation input device 23 outputs input operation information for specifying an input operation performed by the user via the touch panel and the switch.

The BLE communicator device 24, which may also be referred to as a BLE communicator, or a BLE transceiver, performs short-range wireless communication by a method based on BLE. The communicator device 25, which may also be referred to as a communicator or a transceiver, performs data communication via a mobile phone communication network. The imager device 26, which may also be referred to as an imager, includes a camera (not shown), and outputs image data obtained by photographing with the camera to the controller device 27.

The controller device 27, which may also be referred to as a controller, a control circuit, or a processor, is an electronic controller device mainly configured as a microcomputer (i.e., computer). As one example, the microcomputer includes a CPU, a ROM, a RAM, and I/O interfaces. Various functions by the microcomputer are realized by allowing the CPU to execute a program stored in a non-transitory tangible storage medium. In this example, the ROM corresponds to a non-transitory tangible storage medium in which the program is stored. A method corresponding to the program is executed by executing the program. A part or all of the functions executed by the CPU may be configured as hardware by one or more ICs or the like. The number of microcomputers in the controller device 27 may be one or more.

The controller device 27 performs various processes based on inputs from the data storage device 22, the operation input device 23, the BLE communicator device 24, the communicator device 25, and the imager device 26, to thereby control the display device 21, the data storage device 22, the BLE communicator device 24, the communicator device 25, and the imager device 26.

The ROM in the controller device 27 stores a destination setting application program 28 for setting a destination by determining a destination and transmitting the destination to the navigation apparatus 2. The destination setting application is started by the execution of the destination setting application program 28 by an input operation performed by the user of the smartphone 3 via the operation input device 23. The destination determination process and the destination transmission process are now ready to be executed. That is, when input operation information for executing the destination determination process is input from the operation input device 23 after the destination setting application is activated, the controller device 27 executes the destination determination process. When the input operation information for executing the destination transmission process is input from the operation input device 23 after the destination setting application is activated, the controller device 27 executes the destination transmission process. The destination determination process displays a map on the display screen in the display device 21 and determines a destination based on input operation information from the operation input device 23. The destination transmission process will be described later.

Next, a procedure of a destination setting process executed by the controller device 18 of the navigation apparatus 2 will be described. The destination setting process is executed when the user performs an input operation for starting the destination setting process via the operation input device 15 (for example, a switch).

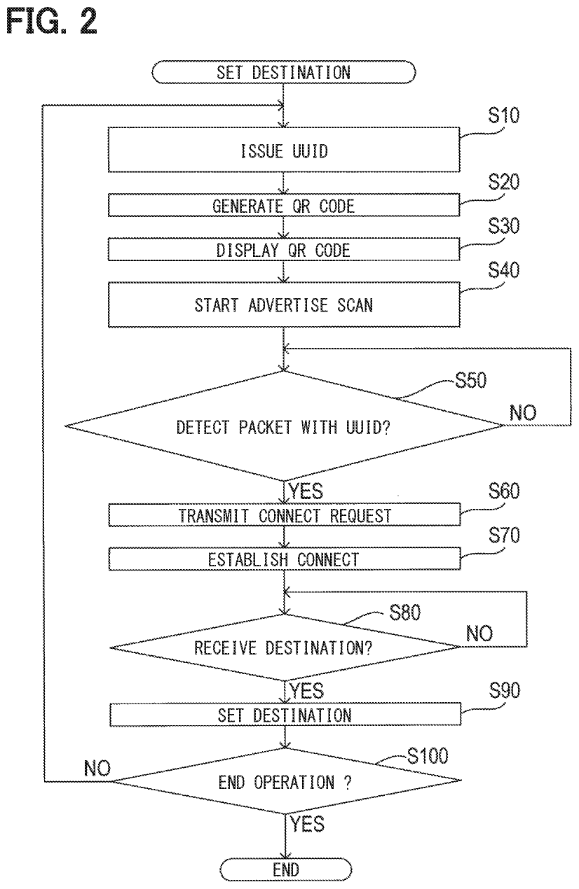

When the destination setting process is executed, the controller device 18 first issues a random UUID in S10 as shown in FIG. 2. UUID is an abbreviation for Universally Unique Identifier. The random UUID is a 128-bit numerical value, and is represented by 32 characters in hexadecimal. Specifically, the controller device 18 randomly generates a 128-bit numerical value by, for example, a random number algorithm.

Further, in S20, the controller device 18 generates a QR code in which the random UUID issued in S10 is embedded. Further, in S30, the controller device 18 displays the QR code generated in S20 on the display screen of the display device 13. QR code is a registered trademark.

Then, in S40, the controller device 18 starts an advertisement scan. Specifically, the controller device 18 starts receiving the advertisement packet by the BLE communicator device 17. Next, in S50, the controller device 18 determines whether an advertisement packet including the random UUID issued in S10 (hereinafter, a target advertisement packet) is detected. Specifically, it is determined whether the random UUID issued in S10 is stored in the advertisement packet received by the BLE communicator device 17.

Here, when the target advertisement packet is not detected, the controller device 18 repeats the process of S50, and waits until the target advertisement packet is detected. When detecting the target advertisement packet, the controller device 18 transmits a connection request to the communication apparatus that transmitted the target advertisement packet in S60. Further, in S70, the controller device 18 performs pairing with the communication apparatus that has transmitted the target advertisement packet in accordance with the BLE standard specification. After the pairing is completed, a short-range wireless communication connection based on the BLE-compliant method is established.

Then, in S80, controller device 18 determines whether destination data has been received from the communication apparatus that has established the connection. Here, when the destination data has not been received, the controller device 18 repeats the processing of S80, and waits until the destination data is received. Upon receiving the destination data, the controller device 18 sets the destination indicated by the received destination data as the destination of the route guidance process performed by the navigation apparatus 2 in S90.

Thereafter, in S100, the controller device 18 determines whether an input operation for terminating the destination setting process (hereinafter, a setting process end operation) has been performed by the user via the operation input device 15. Here, when the setting process end operation is not performed, the controller device 18 proceeds to S10. On the other hand, when the setting process end operation is performed, the controller device 18 ends the destination setting process.

Next, a procedure of a destination transmission process executed by the controller device 27 of the smartphone 3 will be described. The destination transmission process is executed by performing an input operation for executing the destination transmission process via the operation input device 23 (for example, a touch panel).

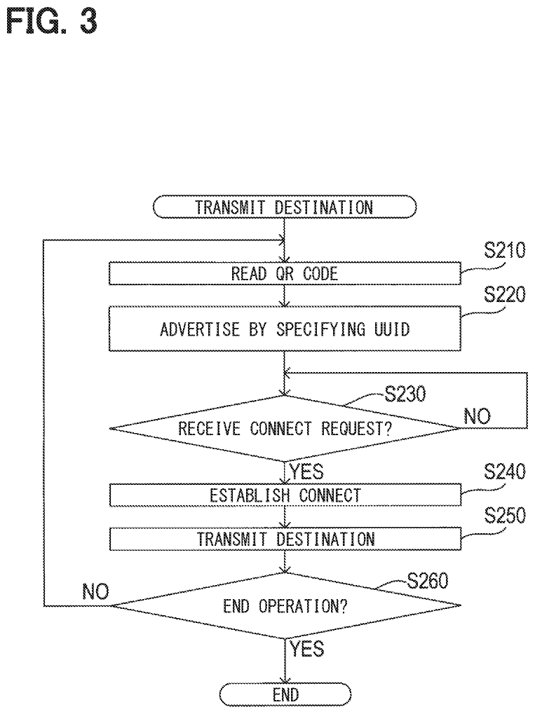

When the destination transmission process is executed, the controller device 27 first reads a QR code in S210 as shown in FIG. 3. Specifically, the controller device 27 first obtains image data obtained by the imager device 26 photographing with the camera. Further, the controller device 27 decodes the QR code included in the acquired image data. Then, the controller device 27 sets the decoded data as the UUID read from the QR code.

Then, in S220, the controller device 27 specifies the read UUID and advertises it. Specifically, the controller device 27 broadcasts the advertisement packet storing the UUID read in S210 from the BLE communicator device 24.

Then, in S230, the controller device 27 determines whether the BLE communicator device 24 has received the connection request. Here, when the connection request has not been received, the controller device 27 repeats the processing of S230, and waits until the connection request is received. Then, upon receiving the connection request, the controller device 27 performs pairing with the communication apparatus that transmitted the connection request according to the BLE standard specification in S240. After the pairing is completed, a short-range wireless communication connection based on the BLE-compliant method is established.

Further, in S250, the controller device 27 transmitted the destination data from the BLE communicator device 24 to the communication apparatus that is the transmission source of the connection request. The destination data indicates the position of the destination determined in the destination determination process before the destination transmission process was performed.

Thereafter, in S260, the controller device 27 determines whether an input operation for ending the destination transmission process (hereinafter, a transmission process end operation) has been performed by the user via the operation input device 23. Here, if the transmission process end operation has not been performed, the controller device 18 proceeds to S210. On the other hand, when the transmission process end operation is performed, the controller device 18 ends the destination transmission process.

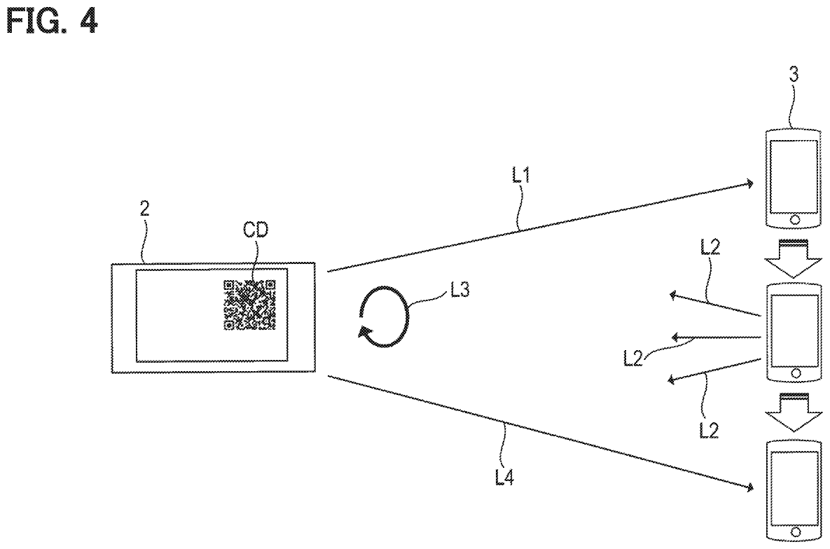

Next, a procedure until a connection is established between the navigation apparatus 2 and the smartphone 3 will be described. As shown in FIG. 4, the navigation apparatus 2 displays a QR code CD in which the issued random UUID is embedded. Then, the smartphone 3 acquires a random UUID by photographing the QR code CD as indicated by an arrow L1. Further, the smartphone 3 broadcasts an advertisement packet storing a random UUID, as indicated by arrows L2.

After displaying the QR code CD, the navigation apparatus 2 executes an advertisement scan as indicated by an arrow L3. Then, when detecting the advertisement packet including the issued random UUID, the navigation apparatus 2 transmits a connection request to the smartphone 3 that has transmitted the advertisement packet, as indicated by an arrow L4.

After the navigation apparatus 2 transmits the connection request, the connection confirmation (that is, pairing) is performed on both the navigation apparatus 2 and the smartphone 3 in accordance with the BLE standard specification. Then, after the connection is confirmed, the connection is established. Once the pairing is performed, the navigation apparatus 2 stores the information for identifying the connection destination terminal, and thereafter connects to the smartphone 3 without performing the pairing.

The destination setting system 1 configured as described above includes the navigation apparatus 2 and the smartphone 3 that perform wireless communication with each other. The navigation apparatus 2 randomly generates a random UUID that is to be included in an advertisement packet transmitted wirelessly by broadcast from the smartphone 3. The navigation apparatus 2 displays a QR code that can specify a random UUID.

The smartphone 3 acquires the QR code displayed by the navigation apparatus 2. The smartphone 3 specifies a random UUID based on the acquired QR code. The smartphone 3 wirelessly transmits an advertisement packet including the specified random UUID by broadcast.

As described above, in the destination setting system 1, the navigation apparatus 2 displays the QR code capable of specifying the random UUID, and the smartphone 3 acquires the QR code displayed by the navigation apparatus 2. For this reason, in the destination setting system 1, when the smartphone 3 exists in an area where the user of the smartphone 3 can view the QR code displayed by the navigation apparatus 2, the smartphone 3 is enabled to acquire the QR code from the navigation apparatus 2. For this reason, the destination setting system 1 can suppress occurrence of a situation where an unintended communication apparatus acquires a QR code. Thereby, the destination setting system 1 can suppress connection confirmation (that is, pairing) with an unintended communication apparatus.

In the destination setting system 1, the navigation apparatus 2 randomly generates a random UUID. That is, the navigation apparatus 2 changes the random UUID randomly. Suppose a case where in the destination setting system 1, an unintended communication apparatus receives an advertisement packet wirelessly transmitted by broadcast from the smartphone 3. Even in such a case, when the unintended communication apparatus wirelessly thereafter transmits an advertisement packet including a random UUID, there is a high possibility that the random UUID is invalid. Thereby, the destination setting system 1 can suppress connection confirmation with an unintended communication apparatus.

The QR code is a two-dimensional code in which a random UUID is embedded. Thereby, the destination setting system 1 can cause the smartphone 3 to acquire the QR code by a simple method in which the user of the smartphone 3 captures the QR code with the smartphone 3.

Further, the navigation apparatus 2 determines whether the generated random UUID is included in the advertisement packet received from the smartphone 3. Then, when the navigation apparatus 2 determines that a random UUID is included, the navigation apparatus 2 establishes a connection with the smartphone 3.

In the embodiment described above, the destination setting system 1 corresponds to a communication system, the navigation apparatus 2 corresponds to a first communication apparatus, the smartphone 3 corresponds to a second communication apparatus, and the destination setting application program 28 corresponds to a communication program.

In addition, S10 corresponds to processing as a random generating section or unit, and S20 and S30 correspond to a displaying section or unit. The advertisement packet corresponds to broadcast information, the random UUID corresponds to identification information, and the QR code corresponds to specification information.

The imager device 26 corresponds to an acquiring section or unit, S210 corresponds to processing as a specifying section or unit, and S220 corresponds to processing as a transmitting section or unit. In addition, S50 corresponds to processing as an information determining section or unit, and S60 and S70 correspond to processing as a connection establishing section or unit.

### Second Embodiment

Hereinafter, a second embodiment of the present disclosure will be described with reference to the drawings. Note that in the second embodiment, portions different from the first embodiment will be described. The same reference signs are given to common elements or components.

The destination setting system 1 of the second embodiment is different from the first embodiment in that the destination setting process and the destination transmission process are changed. The destination setting process according to the second embodiment is different from the first embodiment in that the processing in S10, S20, S30, S40, and S50 is omitted, and the processing in S410, S420, S430, S440, and S450 is added.

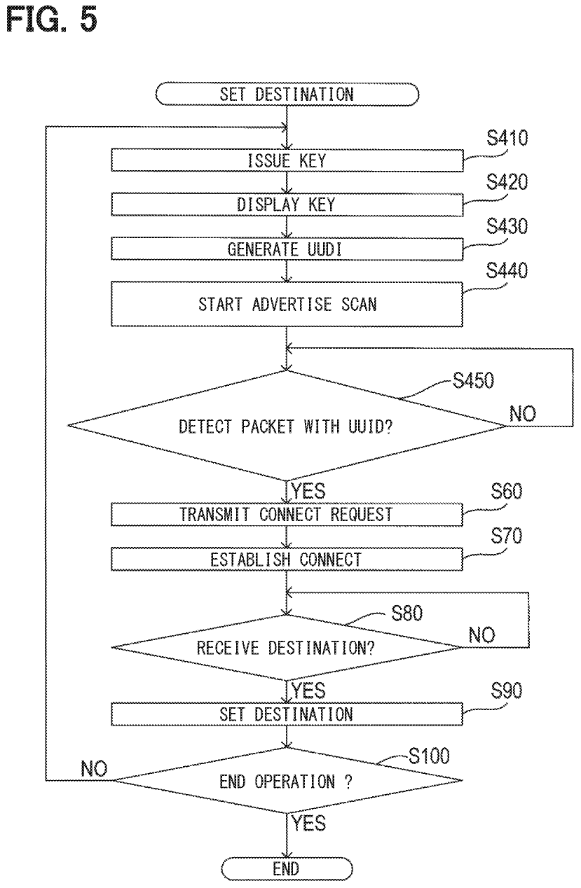

That is, when the destination setting process of the second embodiment is executed, the controller device 18 first issues a random key in S410 as shown in FIG. 5. The random key is a numeric string of a plurality of digits (for example, four digits in the present embodiment). Specifically, the controller device 18 randomly generates a multi-digit number sequence by, for example, a random number algorithm.

Further, the controller device 18 displays the random key issued in S410 on the display screen of the display device 13 in S420. Then, in S430, the controller device 18 generates a UUID using the random key issued in S410. Specifically, the controller device 18 first creates one character string by combining the Salt character string with the numeral string of the random key issued in S410. Further, the controller device 18 generates an SHA2 hash from the created character string. This SHA2 hash has a 256-bit value. Next, the controller device 18 converts the generated SHA2 hash into a character string. Then, the controller device 18 extracts and combines the odd-numbered or even-numbered characters in the characterized SHA2 hash. As a result, a 128-bit UUID is generated.

Next, in S440, the controller device 18 starts an advertisement scan. Specifically, the controller device 18 starts receiving the advertisement packet by the BLE communicator device 17. Then, in S450, similarly to S50, the controller device 18 determines whether an advertisement packet including the UUID generated in S430 (hereinafter, target advertisement packet) is detected. Here, when the target advertisement packet is not detected, the controller device 18 repeats the processing of S450, and waits until the target advertisement packet is detected. When detecting the target advertisement packet, the controller device 18 proceeds to S60.

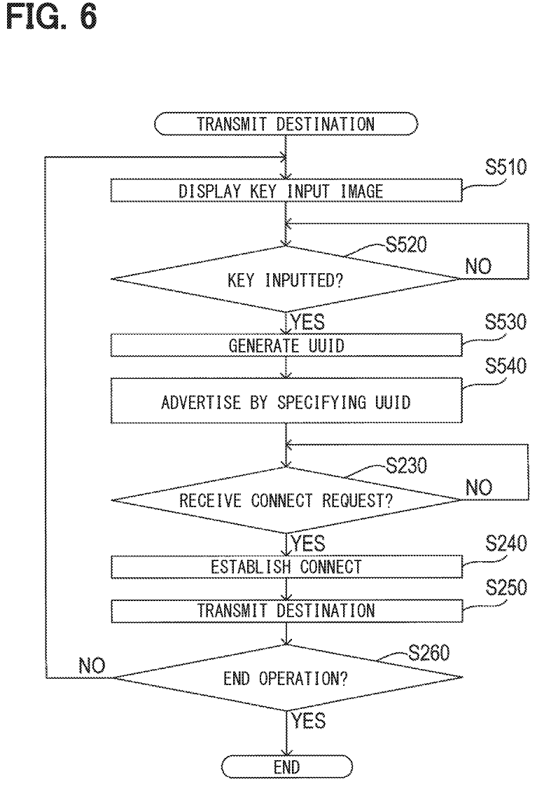

The destination transmission process of the second embodiment differs from the first embodiment in that the processing of S210 and S220 is omitted and that the processing of S510, S520, S530, and S540 is added. That is, when the destination transmission process of the second embodiment is executed, the controller device 27 first displays a random key input image on the display screen of the display device 21 in S510 as shown in FIG. 6. Then, in S520, the controller device 27 determines whether a random key has been input via the operation input device 23.

Here, when the random key has not been input, the controller device 27 repeats the processing of S520, and waits until the random key is input. Then, when the random key is input, the controller device 27 generates a UUID using the input random key in S530 in the same manner as in S430.

Next, in S540, the controller device 27 specifies and advertises the UUID generated in S530 in a manner similar to S220, and proceeds to S230. Next, a procedure until a connection is established between the navigation apparatus 2 and the smartphone 3 will be described.

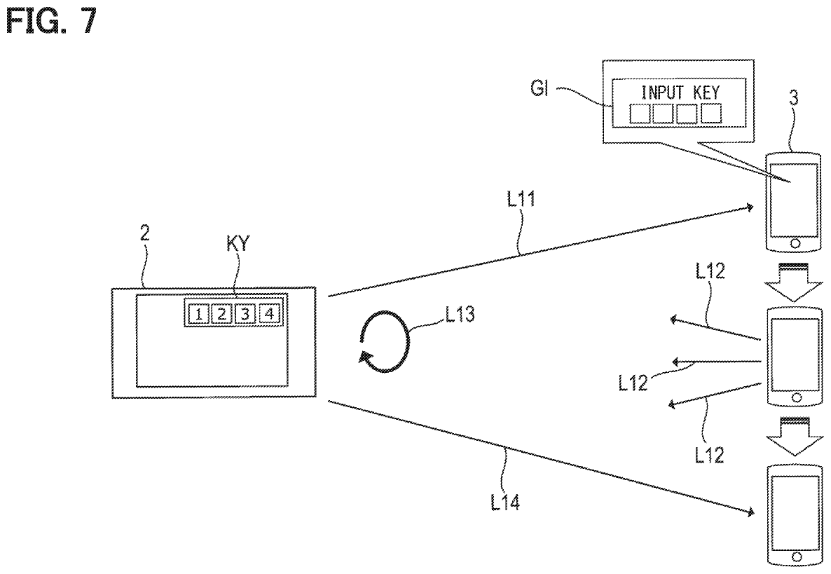

As shown in FIG. 7, the navigation apparatus 2 displays the issued random key KY. In addition, the smartphone 3 displays the random key input image GI. Then, when the random key KY is input into the random key input image GI as indicated by an arrow L11, the smartphone 3 broadcasts an advertisement packet storing the generated UUID as indicated by arrows L12.

After displaying the random key KY, the navigation apparatus 2 executes the advertisement scan as indicated by an arrow L13. When detecting the advertisement packet including the generated UUID, the navigation apparatus 2 transmits a connection request to the smartphone 3 that has transmitted the advertisement packet as indicated by an arrow L14.

After the navigation apparatus 2 transmits the connection request, the connection is confirmed by both the navigation apparatus 2 and the smartphone 3 in accordance with the BLE standard specification. Then, after the connection is confirmed, the connection is established.

The destination setting system 1 configured as described above includes the navigation apparatus 2 and the smartphone 3 that perform wireless communication with each other. The navigation apparatus 2 randomly generates a UUID included in an advertisement packet transmitted wirelessly by broadcast from the smartphone 3. The navigation apparatus 2 displays a random key that can specify the UUID.

The smartphone 3 acquires the random key displayed by the navigation apparatus 2. The smartphone 3 specifies the UUID based on the acquired random key. The smartphone 3 wirelessly transmits an advertisement packet including the specified UUID by broadcast.

As described above, in the destination setting system 1, the navigation apparatus 2 displays the random key that can specify the UUID, and the smartphone 3 acquires the random key displayed by the navigation apparatus 2. For this reason, in the destination setting system 1, when the smartphone 3 is present in an area where the user of the smartphone 3 can view the random key displayed by the navigation apparatus 2, the smartphone 3 is enabled to acquire a random key from the navigation apparatus 2. For this reason, the destination setting system 1 can suppress the occurrence of a situation where an unintended communication apparatus acquires a random key. Thereby, the destination setting system 1 can suppress confirmation of connection with an unintended communication apparatus.

In the destination setting system 1, the navigation apparatus 2 randomly generates a UUID using a random key. That is, the navigation apparatus 2 changes the UUID randomly. Suppose a case where in the destination setting system 1, an unintended communication apparatus receives an advertisement packet wirelessly transmitted by broadcast from the smartphone 3. In such a case, when an unintended communication apparatus thereafter wirelessly transmits an advertisement packet including the UUID, the possibility that the UUID is invalid becomes high. Thereby, the destination setting system 1 can suppress confirmation of connection with an unintended communication apparatus.

The random key is information including a number or a numerical value. Then, the navigation apparatus 2 randomly generates a random key, and specifies the UUID based on the generated random key, thereby randomly generating a UUID. Thereby, the destination setting system 1 can cause the smartphone 3 to acquire the random key by a simple method in which the user of the smartphone 3 inputs the random key to the smartphone 3.

In the embodiment described above, S410 and S430 correspond to processing as a random generating section or unit, S420 corresponds to processing as a displaying section or unit, UUID corresponds to identification information, and a random key corresponds to specification information.

S510 and S520 correspond to processing as an acquiring section or unit, S530 corresponds to processing as a specifying section or unit, and S540 corresponds to processing as a transmitting section or unit. Although the embodiments of the present disclosure have been described above, the present disclosure is not limited to the above embodiments, and various modifications can be made to implement the present disclosure.

### Modification Example 1

For example, in the first embodiment, the navigation apparatus 2 is an observer, while the smartphone 3 is a broadcaster. However, the navigation apparatus 2 may be a broadcaster while the smartphone 3 may be an observer. Further, in the first embodiment, the mode in which the navigation apparatus 2 displays a QR code and the smartphone 3 transmits the advertisement packet has been described. In contrast, the navigation apparatus 2 may include an imager device 26, the smartphone 3 may display a QR code, and the navigation apparatus 2 may transmit an advertisement packet. In this case, the smartphone 3 corresponds to a first communication apparatus, and the navigation apparatus 2 corresponds to a second communication apparatus. Further, the navigation apparatus 2 is an observer and the smartphone 3 is a broadcaster as in the first and second embodiments, whereas the QR code display or the random key display may be performed on the smartphone 3 side.

### Modification Example 2

In the second embodiment, the form in which the random key is information including a number is described. However, the random key may be information including one or more characters, or the random key may be information including one or more numbers and one or more characters.

A destination setting system 1 (i.e., each of the navigation apparatus 2 and the smartphone 3) and methods thereof described in the present disclosure in the above embodiments may be implemented by one or more special-purpose computers. Such computers may be created (i) by configuring a memory and a processor programmed to execute one or more functions embodied in computer programs, or (ii) by configuring a processor provided by one or more special purpose hardware logic circuits, or (iii) by configuring a combination of (a) a memory and a processor programmed to execute one or more functions embodied in computer programs and (b) a processor provided by one or more hardware logic circuits. The computer programs may be stored, as instructions being executed by a computer, in a tangible non-transitory computer-readable storage medium. In other words, the technique for realizing the functions of each unit included in the destination setting system 1 may not be necessarily realized using software, and some or all of the functions may be realized using one or more hardware circuits. The processor may also be referred to as a controller.

The multiple functions of one element in the above embodiments may be realized by multiple elements or a function of one element may be realized by the multiple elements. In addition, multiple functions of multiple elements may be realized by one element, or a single function realized by multiple elements may be realized by one element. In addition, a part of the configuration of the above embodiments may be omitted. At least a part of the configuration of the above embodiments may be added to or substituted for the configuration of the other above embodiment.

The present disclosure may be implemented in a various forms, in addition to the destination setting system 1 described above, such a system including the destination setting system 1 as an element, a program for causing a computer to function as the destination setting system 1, a non-transitory tangible storage medium such as a semiconductor memory storing the program, a communication method, or the like. The present disclosure can be realized in various forms, such as an actual storage medium and a communication method.

For reference to further explain features of the present disclosure, the description is added as follows.

In a communication system, a communication apparatus receives an advertisement packet wirelessly transmitted by broadcast from another communication apparatus and establishes a communication connection based on the advertisement packet.

The communication system for performing wireless communication includes a broadcaster that transmits data and a plurality of observers that receive data. The broadcaster can transmit an advertisement packet storing its service ID to a plurality of observers. Upon receiving the advertisement packet, an observer establishes a communication connection by transmitting a connection request to the broadcaster that is a transmission source of the advertisement packet storing the service ID to which the observer intends to connect.

The advertisement packet storing the service ID is wirelessly transmitted by broadcast, and thus is received by an unspecified number of observers. Therefore, the broadcaster may establish a connection with an unintended observer. In order to prevent accidental connection with an unintended observer, a process called connection confirmation (so-called pairing) is provided for confirming a connection destination on both sides. However, in this case, every time a connection request is transmitted from an observer to the broadcaster, a confirmation message is displayed on the display screen of each of the broadcaster and the observer. If the broadcaster and the observer correspond to an in-vehicle apparatus and a communication apparatus, a confirmation screen may be displayed on the in-vehicle apparatus by unexpected communication from inside or outside the vehicle during a driving operation or an operation equivalent thereto. In addition, a confirmation message may be continuously displayed on the in-vehicle apparatus due to unexpected communication from a malicious third party.

It is thus desired to suppress confirmation of connection with an unintended communication apparatus.

Aspects of the present disclosure described herein are set forth in the following clauses.

According to a first aspect of the present disclosure, a communication system is provided to include a first communication apparatus and a second communication apparatus performing wireless communication with each other. The first communication apparatus includes: a random generating unit; and a displaying unit. The second communication apparatus includes: an acquiring unit; a specifying unit; and a transmitting unit.

The random generating unit is configured to randomly generate identification information that is to be included in broadcast information transmitted wirelessly by broadcast from the second communication apparatus. The displaying unit is configured to display specification information enabled to specify the identification information.

The acquiring unit is configured to acquire the specification information displayed by the first communication apparatus. The specifying unit is configured to specify the identification information based on the specification information acquired by the acquiring unit. The transmitting unit is configured to transmit wirelessly, by broadcast, the broadcast information including the identification information specified by the specifying unit.

Furthermore, in the communication system according to the first aspect, the first communication apparatus may include at least a first computer including at least a first processor, while the second communication apparatus may include at least a second computer including at least a second processor. In addition, the first computer may be configured to implement the random generating unit, the displaying unit, while the second computer may be configured to implement the acquiring unit, the specifying unit, and the transmitting unit.

In the communication system of the first aspect, the first communication apparatus displays the specification information enabled to specify the identification information, and the second communication apparatus acquires the specification information displayed by the first communication apparatus. For this reason, in the communication system of the first aspect, when the second communication apparatus exists in an area where the user of the second communication apparatus can view the specification information displayed by the first communication apparatus, the second communication can acquire the specification information from the first communication apparatus. The communication system of the first aspect can thus suppress an occurrence of a situation in which an unintended communication apparatus acquires the specification information. Accordingly, the communication system according to the first aspect can suppress the connection confirmation with an unintended communication apparatus.

In the communication system according to the first aspect, the first communication apparatus randomly generates identification information. That is, the first communication apparatus changes the identification information at random. For this reason, in the communication system of the first aspect, an unintended communication apparatus may receive broadcast information wirelessly transmitted by broadcast by the second communication apparatus. In such a case, when the unintended communication apparatus thereafter wirelessly transmits the broadcast information including the identification information, the possibility that the identification information is invalid becomes high. Accordingly, the communication system according to the first aspect can suppress the connection confirmation with an unintended communication apparatus.

According to a second aspect of the present disclosure, a mobile terminal is provided to be used as a second communication apparatus in a communication system including a first communication apparatus and the second communication apparatus that perform wireless communication with each other. The mobile terminal includes: an acquiring unit; a specifying unit; and a transmitting unit.

The mobile terminal according to the second aspect is a communication apparatus used in the communication system according to the first aspect, and can obtain the same effect as the communication system according to the first aspect.

According to a third aspect of the present disclosure, an in-vehicle apparatus mounted to a vehicle is provided to be used as a first communication apparatus in a communication system including the first communication apparatus and a second communication apparatus that perform wireless communication with each other. The in-vehicle apparatus includes: a random generating unit; a displaying unit; an information determining unit; and a connection establishing unit.

The information determining unit is configured to determine whether the broadcast information received from the second communication apparatus includes the identification information generated by the random generating unit. The connection establishing unit is configured to establish a connection with the second communication apparatus when the information determining unit determines that the identification information is included.

Furthermore, the first communication apparatus may include at least a first computer including at least a first processor, and the first computer may be further configured to implement the information determining unit, and the connection establishing unit.

The in-vehicle apparatus according to the third aspect is a communication apparatus used in the communication system according to the first aspect, and can obtain the same effect as the communication system according to the first aspect.

According to a fourth aspect of the present disclosure, a mobile terminal is provided to be used as a first communication apparatus in a communication system including the first communication apparatus and a second communication apparatus that perform wireless communication with each other. The mobile terminal includes: a random generating unit; a displaying unit; an information determining unit; and a connection establishing unit.

The mobile terminal according to the fourth aspect configured as described above is a communication apparatus used in the communication system according to the first aspect, and can obtain the same effect as the communication system according to the first aspect.

According to a fifth aspect of the present disclosure, an in-vehicle apparatus mounted to a vehicle is provided to be used as a second communication apparatus in a communication system including a first communication apparatus and the second communication apparatus that perform wireless communication with each other. The in-vehicle apparatus includes: an acquiring unit; a specifying unit; and a transmitting unit.

The in-vehicle apparatus according to the fifth aspect is a communication apparatus used in the communication system according to the first aspect, and can obtain the same effect as the communication system according to the first aspect. According to a sixth aspect of the present disclosure, a communication program is provided for a computer of a mobile terminal that is used as a second communication apparatus in a communication system including a first communication apparatus and the second communication apparatus that perform wireless communication with each other. The communication program causes the computer to function as: an acquiring unit; a specifying unit; and a transmitting unit.

The computer controlled by the communication program of the sixth aspect can form a part of the communication system of the first aspect, and can obtain the same effect as the communication system of the first aspect.

What is claimed is:

1. A communication system including a first communication apparatus and a second communication apparatus performing wireless communication with each other,
the first communication apparatus comprising:
a random generating unit configured to randomly generate identification information that is to be included in broadcast information transmitted wirelessly by broadcast from the second communication apparatus; and
a displaying unit configured to display specification information enabled to specify the identification information,
the second communication apparatus comprising:
an acquiring unit configured to acquire the specification information displayed by the first communication apparatus;
a specifying unit configured to specify the identification information based on the specification information acquired by the acquiring unit; and
a transmitting unit configured to transmit wirelessly, by broadcast, the broadcast information including the identification information specified by the specifying unit.

2. The communication system according to claim 1, wherein:
the first communication apparatus comprises at least a first computer including at least a first processor, while the second communication apparatus comprises at least a second computer including at least a second processor; and
the first computer is configured to implement the random generating unit, the displaying unit, while the second computer is configured to implement the acquiring unit, the specifying unit, and the transmitting unit.

3. The communication system according to claim 1, wherein:
the specification information is information including a numeral, or a character, or a numeral and character; and
the random generating unit configured to randomly generate the identification information by randomly generating the specification information based on which the identification information is specified.

4. The communication system according to claim 1, wherein
the specification information is a two-dimensional code in which the identification information is embedded.

5. A mobile terminal used as a second communication apparatus in a communication system including a first communication apparatus and the second communication apparatus performing wireless communication with each other,
the mobile terminal used as the second communication apparatus comprising:
an acquiring unit configured to acquire specification information displayed by the first communication apparatus, the specification information being enabled to specify identification information that is to be included in broadcast information transmitted wirelessly by the second communication apparatus by broadcast;
a specifying unit configured to specify the identification information based on the specification information acquired by the acquiring unit; and
a transmitting unit configured to wirelessly transmit the broadcast information including the identification information specified by the specifying unit by broadcast.

6. The mobile terminal according to claim 5, wherein:
the second communication apparatus comprises at least a second computer including at least a second processor; and
the second computer is configured to implement the acquiring unit, the specifying unit, and the transmitting unit.

7. An in-vehicle apparatus mounted to a vehicle, the in-vehicle apparatus being used as a first communication apparatus in a communication system including the first communication apparatus and a second communication apparatus that perform wireless communication with each other,
the in-vehicle apparatus used as the first communication apparatus comprising:
a random generating unit configured to randomly generate identification information that is to be included in broadcast information transmitted wirelessly by broadcast from the second communication apparatus;
a displaying unit configured to display specification information enabled to specify the identification information;
an information determining unit configured to determine whether the broadcast information received from the second communication apparatus includes the identification information generated by the random generating unit; and
a connection establishing unit configured to establish a connection with the second communication apparatus in response to the information determining unit determining that the broadcast information includes the identification information.

8. The in-vehicle apparatus according to claim 7, wherein:
the first communication apparatus comprises at least a first computer including at least a first processor; and
the first computer is configured to implement the random generating unit, the displaying unit, the information determining unit, and the connection establishing unit.

9. A mobile terminal used as a first communication apparatus in a communication system including the first communication apparatus and a second communication apparatus performing wireless communication with each other,
the mobile terminal used as the first communication apparatus comprising:
a random generating unit configured to randomly generate identification information that is to be included in broadcast information transmitted wirelessly by broadcast from the second communication apparatus;
a displaying unit configured to display specification information enabled to specify the identification information;
an information determining unit configured to determine whether the broadcast information received from the second communication apparatus includes the identification information generated by the random generating unit; and
a connection establishing unit configured to establish a connection with the second communication apparatus in response to the information determining unit determining that the broadcast information includes the identification information.

10. The mobile terminal according to claim 9, wherein:
the first communication apparatus comprises at least a first computer including at least a first processor; and
the first computer is configured to implement the random generating unit, the displaying unit, the information determining unit, and the connection establishing unit.

11. An in-vehicle apparatus mounted to a vehicle, the in-vehicle apparatus being used as a second communication apparatus in a communication system including a first communication apparatus and the second communication apparatus that perform wireless communication with each other,
the in-vehicle apparatus used as the second communication apparatus comprising:
an acquiring unit configured to acquire specification information displayed by the first communication apparatus, the specification information being enabled to specify identification information that is to be included in broadcast information transmitted wirelessly by the second communication apparatus by broadcast;
a specifying unit configured to specify the identification information based on the specification information acquired by the acquiring unit; and
a transmitting unit configured to wirelessly transmit the broadcast information including the identification information specified by the specifying unit by broadcast.

12. The in-vehicle apparatus according to claim 11, wherein:
the first communication apparatus comprises at least a first computer including at least a first processor; and
the first computer is configured to implement the acquiring unit, the specifying unit, and the transmitting unit.

13. A computer-implemented communication method executed by at least one computer included in a portable terminal used as a second communication apparatus in a communication system including a first communication apparatus and the second communication apparatus performing wireless communication with each other,
the communication method comprising:
acquiring specification information displayed by the first communication apparatus, the specification information being enabled to specify identify identification information that is to be included in broadcast information wirelessly transmitted by the second communication apparatus by broadcast;
specifying the identification information based on the acquired specification information; and
transmitting wirelessly, by broadcast, the broadcast information including the specified identification information.

14. A non-transitory computer readable storage medium comprising instructions for execution by a computer, the instructions including the communication method according to claim 13, the method being computer-implemented.
